(19) United States
(12) Patent Application Publication
(10) Pub. No.: US 2009/0309920 A1
(43) Pub. Date: Dec. 17, 2009

(54) LIQUID-SPRAY-FAILURE DETECTING DEVICE AND INK-JET RECORDING APPARATUS

(75) Inventors: Hirotaka HAYASHI, Aichi (JP); Kazumasa Ito, Gifu (JP)

Correspondence Address: FOLEY AND LARDNER LLP;SUITE 500, 3000 K STREET NW, WASHINGTON, DC, 20007, US

(73) Assignee: RICOH ELEMEX CORPORATION

(21) Appl. No.: 12/480,373

(22) Filed: Jun. 8, 2009

(30) Foreign Application Priority Data
Jun. 12, 2008 (JP) 2008-154341

(51) Int. Cl. B41J 2/165

(52) U.S. Cl. 347/34

(57) ABSTRACT

A light-emitting element emits a light beam and a light-receiving element receives the light beam emitted from the light-emitting element. The light emitting element is installed in such a manner that the light beam collides with a sprayed liquid droplet so that a spray failure of the liquid droplet is detected based on an output change of the light-receiving element. A mist shielding plate includes an elongated hole through which liquid droplets sprayed from a plurality of nozzles pass and prevents a mist floating apart from the liquid droplets from passing through the elongated hole.

### CROSS-REFERENCE TO RELATED APPLICATIONS

The present application claims priority to and incorporates by reference the entire contents of Japanese priority document 2008-154341 filed in Japan on Jun. 12, 2008.

### BACKGROUND OF THE INVENTION

1. Field of the Invention

The present invention relates to a liquid-spray-failure detecting device and an ink-jet recording apparatus including the liquid-spray-failure detecting device.

2. Description of the Related Art

A conventional ink-jet printer includes a nozzle head that sprays an ink droplet and a liquid-spray-failure detecting device including a light emitting element that emits a light toward the ink droplet sprayed from the nozzle head and a light receiving element that receives the light emitted from the light emitting element. The liquid-spray-failure detecting device is arranged such that the light emitted from the light emitting element collides with a sprayed ink droplet, and detects a spray failure of the ink droplet based on an output change of the light receiving element.

FIGS. 18A to 18F are schematic diagrams for explaining occurrence of a mist m upon a spray operation of the ink droplet in the ink-jet printer. For example, as shown in FIG. 18A, an ink droplet b1 is sprayed from a nozzle hole Nx arranged on a head nozzle surface Hm of a head nozzle. Afterward, as shown in FIG. 18B, ink droplets b2 and b3 are sequentially sprayed from the nozzle hole Nx and combined with the ink droplet b1 to make an ink droplet B as shown in FIGS. 18C and 18D. Ink droplets that have not combined in the ink droplet B are referred to as a satellite Bs, and the satellite Bs floats behind the ink droplet B. Because the satellite Bs is smaller than the ink droplet B, it is easily affected by the air resistance and starts to float out of a trajectory of the ink droplet B as shown in FIGS. 18E and 18F. The floating satellites Bs are referred to as the mist m.

A conventional ink-jet recording apparatus such as an ink-jet printer, for example, as disclosed in Japanese Patent Application Laid-open No. 2006-137138 or Japanese Patent No. 3520471, does not have a configuration to remove the mist m in an active manner.

If the floating mist m enters an optical path of a light beam, a scattered light is generated due to the mist m, which causes a variation in output of the light receiving element and results in an improper detection of the spray failure of the liquid droplet. Furthermore, the floating mist m adheres to an optical system (a lens or the light receiving element), resulting in a degradation of the output of the light emitting element or a degradation of a sensitivity the light receiving element.

When a viscosity of the ink in a nozzle of a nozzle head is high, a conventional ink-jet printer performs a cleaning function to flush the high-viscosity ink from the nozzle. Because an amount of ink sprayed from the nozzle upon a flushing operation is larger than that of the ink sprayed upon a detection operation of liquid-spray-failure, a large amount of mist is generated upon the flushing operation.

If the floating mist apart from the sprayed liquid droplet adheres to a component arranged around and is accumulated on the component, the accumulated mist disturbs spray of the liquid droplet or interferes with movement of the nozzle head because the accumulated mist is in contact with the moving nozzle head.

### SUMMARY OF THE INVENTION

It is an object of the present invention to at least partially solve the problems in the conventional technology.

According to one aspect of the present invention, there is provided a device for detecting a liquid spray failure including a light-emitting element that emits a light beam and a light-receiving element that receives the light beam emitted from the light-emitting element. The light emitting element is installed in such a manner that the light beam collides with a sprayed liquid droplet so that the device detects a spray failure of the liquid droplet based on an output change of the light-receiving element. The device further includes a mist shielding plate that includes an elongated hole through which liquid droplets sprayed from a plurality of nozzles pass and that prevents a mist floating apart from the liquid droplets from passing through the elongated hole.

Furthermore, according to another aspect of the present invention, there is provided an ink-jet recording apparatus including a nozzle head that includes a plurality of nozzles arranged in line each spraying an ink droplet and an ink-spray-failure detecting device. The ink-spray-failure detecting device includes a light-emitting element that emits a light beam, a light-receiving element that receives the light beam emitted from the light-emitting element. The light emitting element is installed in such a manner that the light beam collides with a sprayed ink droplet so that the ink-spray-failure detecting device detects a spray failure of the ink droplet based on an output change of the light-receiving element. The ink-spray-failure detecting device further includes a mist shielding plate that includes an elongated hole through which ink droplets sprayed from the nozzles pass and that prevents a mist floating apart from the ink droplets from passing through the elongated hole.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1A is a front view of an ink-jet printer including a liquid-spray-failure detecting device according to an embodiment of the present invention;

FIG. 1B is a perspective view of a part of the ink-jet printer according to the embodiment;

FIG. 2 is a schematic diagram of the liquid-spray-failure detecting device according to the embodiment and a nozzle head shown in FIG. 1A;

FIG. 3 is a light intensity distribution chart of a light beam in the liquid-spray-failure detecting device according to the embodiment;

FIG. 4 is a schematic diagram for explaining strike positions where an ink droplet strikes the light beam as seen from a position of a nozzle hole shown in FIG. 2;

FIG. 5 is a waveform chart of light output from a light-receiving element shown in FIG. 2 when the ink droplet strikes the light beam at the strike positions;

FIG. 6 is a schematic diagram of the liquid-spray-failure detecting device according to the embodiment as seen from the irradiation direction of the light beam;

FIG. 7 is a graph for explaining detection conditions of mist depending on a position of a mist shielding plate shown in FIG. 1A;

FIG. 8 is a graph for explaining a relation between a distance between the nozzle head and the mist shielding plate and a width of an elongated side of a hole shown in FIG. 1B in the case of the mist having a medium diameter;

FIG. 9 is a schematic diagram for explaining a detection operation of liquid-spray-failure and an flushing operation that are performed by the nozzle head and a liquid-spray-failure detecting device at separate areas according to a first modified example of the embodiment;

FIG. 10 is a schematic diagram for explaining the detection operation and the flushing operation that are performed by the nozzle head and a liquid-spray-failure detecting device at separate areas according to a second modified example of the embodiment;

FIG. 11 is a schematic diagram for explaining a liquid-spray-failure detecting device including mist suction members according to a third modified example of the embodiment;

FIG. 12 is a schematic diagram for explaining a liquid-spray-failure detecting device according to a fourth modified example of the embodiment;

FIG. 13 is a schematic diagram for explaining the flushing operation performed by the liquid-spray-failure detecting device according to the fourth modified example;

FIG. 14 is a schematic diagram for explaining a liquid-spray-failure detecting device according to a fifth modified example of the embodiment;

FIG. 15 is a schematic diagram for explaining a liquid-spray-failure detecting device according to a sixth modified example of the embodiment;

FIG. 16 is a schematic diagram for explaining a cleaning unit according to a seventh modified example of the embodiment;

FIG. 17 is a schematic diagram for explaining a mist shielding plate according to an eighth modified example of the embodiment; and

FIGS. 18A to 18F are schematic diagrams for explaining occurrence of mist upon a spray operation of the ink droplet in the ink-jet printer according to the embodiment.

### DETAILED DESCRIPTION OF THE PREFERRED EMBODIMENTS

Exemplary embodiments of the present invention are explained in detail below with reference to the accompanying drawings.

Although an ink-jet printer will be explained in the following description, the present invention can be applied to an ink-jet recording apparatus, such as a copier or a facsimile, employing an ink-jet system to form an image on a recording medium.

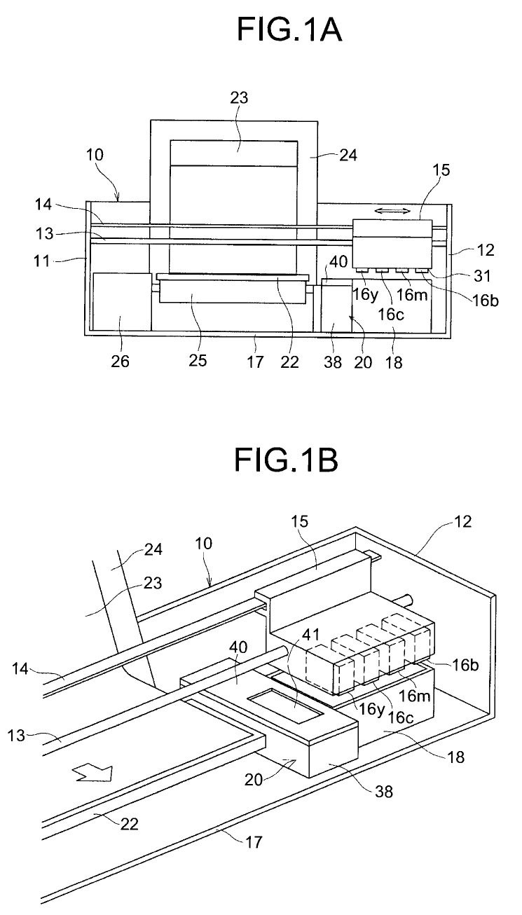

FIG. 1A is a front view of an ink-jet printer including a liquid-spray-failure detecting device 20 according to an embodiment of the present invention, and FIG. 1B is a perspective view of a part of the ink-jet printer.

The ink-jet printer includes a casing 10. Side plates 11 and 12 are arranged on both sides of the casing 10, and a guide shaft 13 and a guide plate 14 are arranged between the side plates 11 and 12 in parallel to each other. A carriage 15 is supported by the guide shaft 13 and the guide plate 14. An endless belt (not shown) is attached to the carriage 15. The endless belt is supported by a drive pulley (not shown) and a driven pulley (not shown) that are arranged on both sides of the casing 10. The driven pulley is rotated to move the endless belt with the rotation of the drive pulley, so that the carriage 15 is movable in the lateral direction indicated by a two-headed arrow shown in FIG. 1A.

The carriage 15 includes nozzle heads 16y, 16c, 16m, and 16b (hereinafter, simply referred to as “nozzle head 16” as appropriate) corresponding to four colors of yellow, cyan, magenta, and black. The nozzle heads 16y, 16c, 16m, and 16b are arranged in a direction along which the carriage 15 is movable. Each of the nozzle heads 16y, 16c, 16m, and 16b includes a row of nozzle holes that are linearly arranged on a downward-facing nozzle surface. Although not shown, the row of the nozzle holes is arranged in a direction perpendicular to the direction along which the carriage 15 is movable.

When the carriage 15 is located at a home position on the extreme right of the casing 10 as shown in FIG. 1A, each of the nozzle heads 16y, 16c, 16m, and 16b is opposed to an independent restoration device 18 mounted on a bottom plate 17 of the casing 10. The independent restoration device 18 enables the ink-jet printer itself to independently restore spray failure of an ink droplet by sucking out ink from the nozzle hole in which the spray failure is detected by the liquid-spray-failure detecting device 20.

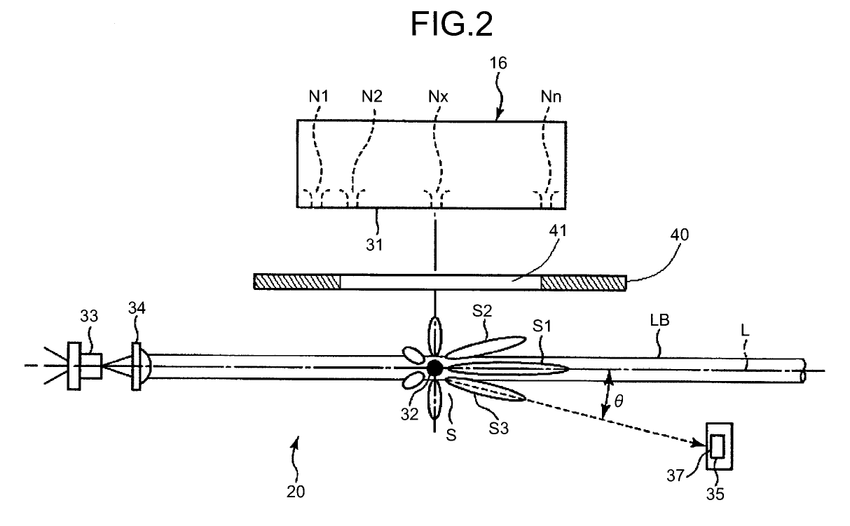

The liquid-spray-failure detecting device 20 is contained in a casing 38 having a rectangular solid shape, and the casing 38 is mounted on the bottom plate 17. The liquid-spray-failure detecting device 20 is arranged next to the independent restoration device 18. The liquid-spray-failure detecting device 20 will be explained in detail later with reference to FIG. 2 and subsequent figures.

A plate-shaped platen 22 is arranged adjacent to the liquid-spray-failure detecting device 20. A feed board 24 is arranged at a tilt on the rear side of the platen 22. The feed board 24 feeds a recording medium 23 such as a sheet to the platen 22. Although not shown, a feed roller is arranged to feed the recording medium 23 from the feed board 24 to the platen 22. Furthermore, a conveying roller 25 is arranged to convey the recording medium 23 from the platen 22 in a direction indicated by an arrow shown in FIG. 1B thereby discharging the recording medium 23 to the front side of the ink-jet printer.

A drive device 26 is arranged on the extreme left of the bottom plate 17 as shown in FIG. 1A. The drive device 26 drives the feed roller, the conveying roller 25, and the like, as well as the drive pulley to drive the endless belt thereby moving the carriage 15.

When an image forming operation is performed, the drive device 26 causes the recording medium 23 to be conveyed to the platen 22 whereby the recording medium 23 is set at a predetermined position, and causes the carriage 15 to be moved above the recording medium 23 leftward in FIG. 1A while the nozzle heads 16y, 16c, 16m, and 16b sequentially spray ink droplets from the nozzle holes, so that an image is formed on the recording medium 23. After the image is formed on the recording medium 23, the carriage 15 is moved back rightward in FIG. 1A, while the recording medium 23 is conveyed by a predetermined distance in the direction indicated by the arrow in FIG. 1B.

The carriage 15 is then moved leftward in FIG. 1A again, while the nozzle heads 16y, 16c, 16m, and 16b sequentially spray ink droplets from the nozzle holes, so that an image is formed on the recording medium 23. After the image is formed on the recording medium 23, the carriage 15 is moved back rightward in FIG. 1A, while the recording medium 23 is conveyed by a predetermined distance in the direction indicated by the arrow in FIG. 1B. The above process is repeated so that the entire image is formed on the recording medium 23.

FIG. 2 is a schematic diagram of the liquid-spray-failure detecting device 20 and the nozzle head 16.

The nozzle head 16 includes a downward-facing head nozzle surface 31. A row of linearly arranged nozzle holes N1, N2, . . . , Nx, . . . and Nn is formed on the head nozzle surface 31. Each of the nozzle holes N1, N2, . . . , Nx, . . . and Nn selectively sprays an ink droplet 32 as a liquid droplet.

The liquid-spray-failure detecting device 20 detects spray failure of the ink droplet 32 from each of the nozzle holes N1, N2, . . . , Nx, . . . and Nn. The liquid-spray-failure detecting device 20 includes a light-emitting element 33 that emits a light, a collimating lens 34 that collimates the light emitted from the light-emitting element 33 thereby forming a light beam LB, and a light-receiving element 35 such as a photodiode that receives the light emitted from the light-emitting element 33.

The liquid-spray-failure detecting device 20 is arranged in a direction intersecting a spray direction of the ink droplet 32 such that the light beam LB strikes the floating ink droplet 32 sprayed from the head nozzle surface 31 and such that a light axis L of the light beam LB is located in parallel to the row of the nozzle holes N1, N2, . . . , Nx, . . . and Nn at a position away from the head nozzle surface 31 by a certain distance.

The light-receiving element 35 is arranged at a position lower than the light beam LB with an angle θ from the light axis L so that an acceptance surface 37 included in the light-receiving element 35 is located outside of a beam diameter of the light beam LB having an elliptical shape on cross section.

The ink droplet 32 is sprayed from the nozzle hole Nx, and then the light beam LB strikes the ink droplet 32 whereby scattered lights S including scattered lights S1, S2, and S3 are generated. The scattered light S3 is received by the acceptance surface 37, and output of the light-receiving element 35 is measured as a voltage value (light output value), so that data on the received light is obtained. It is detected whether the ink droplet 32 is sprayed or whether there is liquid-spray-failure such that the ink droplet 32 is sprayed at an angle based on variation in output of the light-receiving element 35.

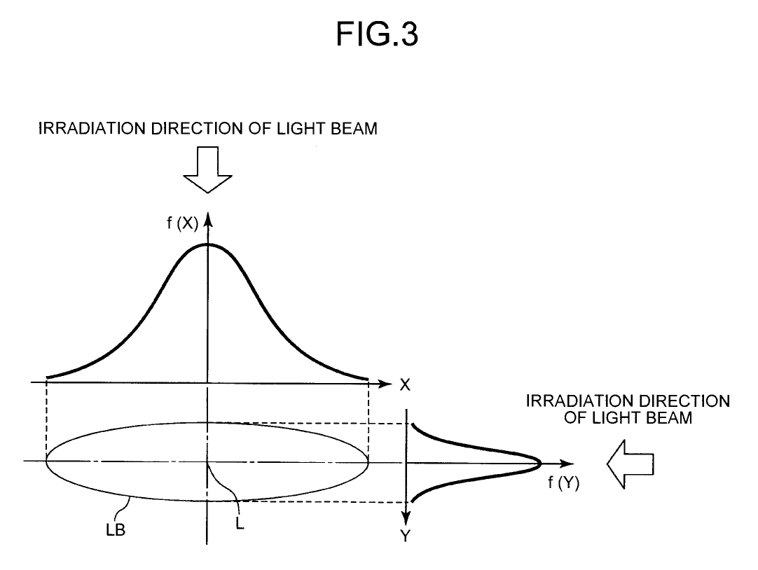

In the embodiment, a semiconductor laser is used as the light-emitting element 33. If the semiconductor laser is used as the light-emitting element 33, a light is emitted from the light-emitting element 33 with angles in the perpendicular and the lateral directions. In the case of a generally used semiconductor laser, a light is emitted at an angle of 14 degrees in the perpendicular direction and at an angle of 30 degrees in the lateral direction. If such a light is collimated by the collimating lens 34, the collimated light has an elliptical shape on cross section with an aspect ratio as shown in FIG. 3.

FIG. 3 is a light intensity distribution chart in directions X and Y in which the length of the beam diameter of the light beam LB in the longitudinal direction is indicated by a reference mark X and the length of the beam diameter of the light beam LB in the transverse direction is indicated by a reference mark Y. This is Gaussian distribution in which the light intensity is highest at the center (the light axis L) of the light beam LB and is reduced toward the edge of the light beam LB.

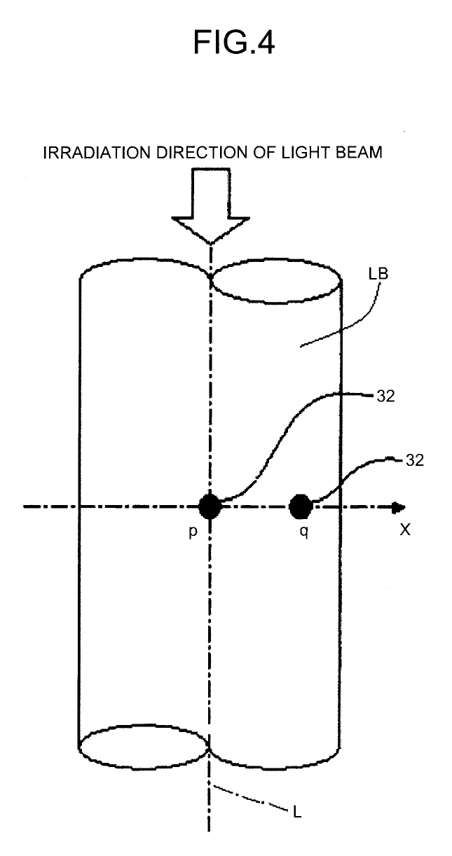

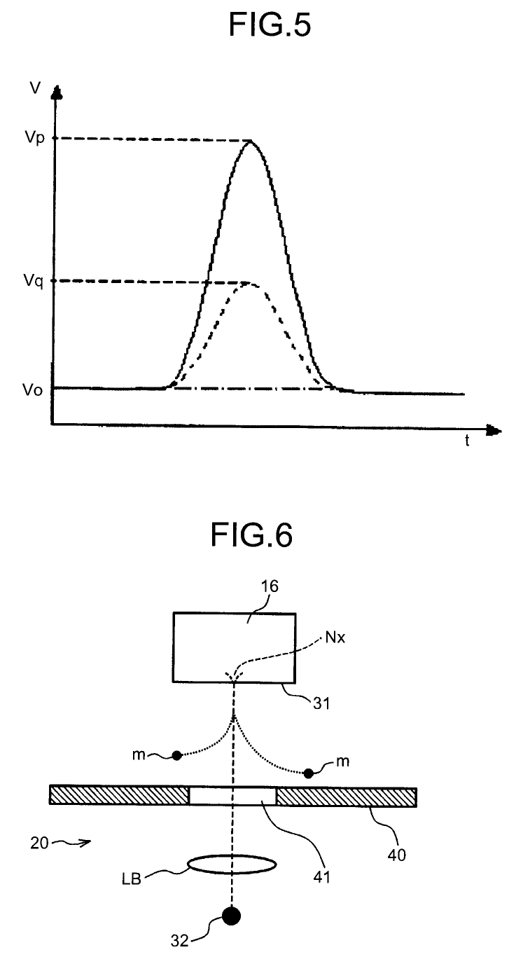

FIG. 4 is a schematic diagram for explaining strike positions p and q where the ink droplet 32 strikes the light beam LB as seen from the position of the nozzle hole Nx. FIG. 5 is a waveform chart of light output from the light-receiving element 35 when the ink droplet 32 strikes the light beam LB at the strike positions p and q.

A light output value obtained when the ink droplet 32 is sprayed to a position (the strike position q) in the direction X (a radial direction of the light beam LB perpendicular to an irradiation direction of the light beam LB) is lower than a light output value obtained when the light beam LB is sprayed to a position (the strike position p) at the center (Vp>Vq) as shown in FIG. 5, because the light intensity of the light beam LB is obtained in Gaussian distribution as shown in FIG. 3. Furthermore, the light output value is reduced toward the edge of the light beam LB.

Specifically, if the row of the nozzle holes N1, N2, . . . , Nx, . . . and Nn is located above the light axis L, because the properly sprayed ink droplet 32 floats in the vertical direction, the ink droplet 32 passes at the strike position p at the center of the light beam LB. However, if the ink droplet 32 is sprayed at an angle, the ink droplet 32 passes at the strike position q out of the center of the light beam LB. If the ink droplet 32 fails to be sprayed, the ink droplet 32 does not pass through the light beam LB.

Because the properly sprayed ink droplet 32 passes through the center of the light beam LB where the light intensity is highest, intensity of the scattered light is high and the light output value Vp can be obtained (indicated by a solid line shown in FIG. 5). On the other hand, if the ink droplet 32 is sprayed at an angle, the ink droplet 32 passes through a position out of the center of the light beam LB, and therefore the lower light output value Vq is obtained (Vq<Vp) (indicated by a broken line shown in FIG. 5). If the ink droplet 32 fails to be sprayed, because the ink droplet 32 does not pass through the light beam LB, a light output value Vo is obtained (indicated by a dashed-dotted line shown in FIG. 5). Thus, it is possible to detect whether the ink droplet 32 fails to be sprayed or the ink droplet 32 is sprayed at an angle based on the light output. Because flare of the light beam LB is received by the light-receiving element 35, the light output value Vo is obtained even if the ink droplet 32 does not pass through the light beam LB.

As shown in FIG. 1B, the upper portion of the casing 38 is covered with a mist shielding plate 40. The mist shielding plate 40 is attached to the casing 38 with a screw clamp, or the like, and is located between the head nozzle surface 31 and the light beam LB when the nozzle head 16 is located at a position for detecting the liquid-spray-failure. The mist shielding plate 40 includes an elongated hole 41 used for detecting the liquid-spray-failure in a rectangle shape, so that the mist shielding plate 40 allows the ink droplet 32 sprayed from the nozzle holes N1, N2, . . . , Nx, . . . and Nn to pass through the elongated hole 41 and prevents the mist m floating apart from the ink droplet 32 from passing through the elongated hole 41.

FIG. 6 is a schematic diagram of the liquid-spray-failure detecting device 20 as seen from the irradiation direction of the light beam LB. The light-emitting element 33, the collimating lens 34, and the light-receiving element 35 are not shown in FIG. 6.

The nozzle head 16 is moved to a position corresponding to the elongated hole 41, and then the ink droplet 32 is sprayed from the nozzle hole Nx. After the sprayed ink droplet 32 passes through the elongated hole 41, the ink droplet 32 strikes the light beam LB whereby the scattered light S is generated, and only the scattered light S is received by the light-receiving element 35.

The mist shielding plate 40 prevents the mist m generated upon the spray operation of the ink droplet 32 from floating near the mist shielding plate 40 on the side of the light beam LB. Thus, it is possible to properly detect the spray failure of the ink droplet 32 without being affected by the mist m and without false detection due to the mist m. It is also possible to avoid the mist m from adhering to an optical system thereby preventing output reduction of the light-emitting element 33 and sensitivity reduction of the light-receiving element 35, so that the spray failure of the ink droplet 32 can be properly detected.

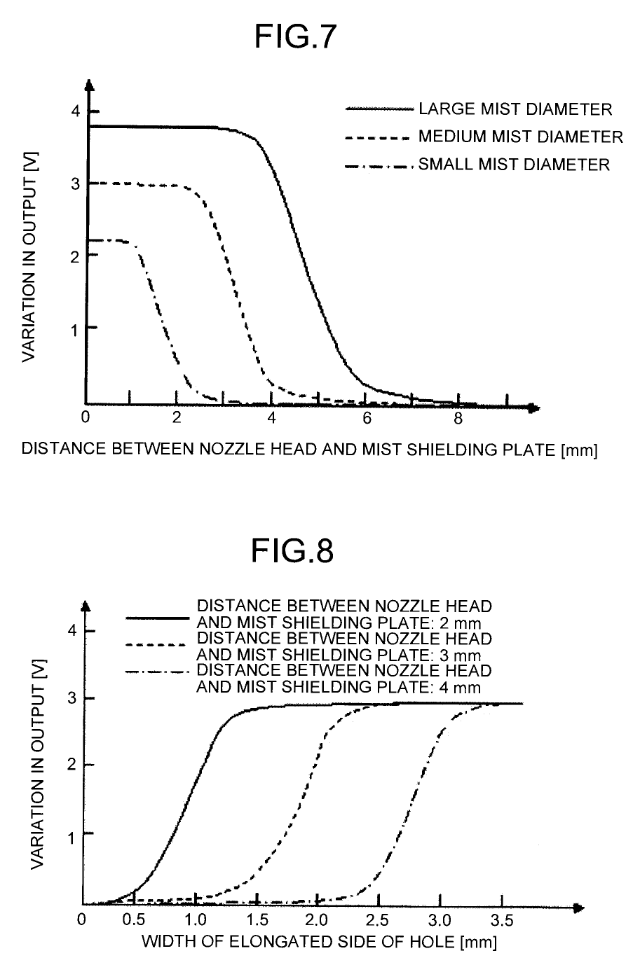

FIG. 7 is a graph for explaining detection conditions of the mist m depending on a position of the mist shielding plate 40.

The horizontal axis indicates a distance between the nozzle head 16 and the mist shielding plate 40, and the vertical axis indicates variation in output of the light-receiving element 35 due to the mist m. When the mist shielding plate 40 is located away from the nozzle head 16, variation in output of the light-receiving element 35 is reduced. Furthermore, as described above, when the generated mist m floats on an optical path of the light beam LB, the output of the light-receiving element 35 is increased. If the diameter of the mist m is large, the intensity of the scattered light is high, influence of air resistance is reduced, and a distance from the trajectory of the ink droplet 32 to the mist m is small. On the other hand, if the diameter of the mist m is small, the intensity of the scattered light is low, and the distance from the trajectory to the mist m is large.

Thus, a rate at which the mist m enters the optical path of the light beam LB is changed depending on a position where the mist shielding plate 40 is arranged. If the diameter of the mist m is large, it is necessary to locate the nozzle head 16 and the mist shielding plate 40 at a sufficient distance interposed therebetween. Otherwise, the mist m passes through the elongated hole 41 and enters the optical path of the light beam LB.

If the mist shielding plate 40 is located away from the head nozzle surface 31 by a distance (for example, about 6 millimeters), it is possible to prevent the mist m with various diameters from entering the optical path of the light beam LB and the optical system, thereby avoiding contamination of the optical system due to the mist m and the false detection. Moreover, if it is predicted that only the mist m having a medium diameter is generated, the mist shielding plate 40 is located away from the head nozzle surface 31 by about 4 mm, and if it is predicted that only the mist m having a small diameter is generated, the mist shielding plate 40 is located away from the head nozzle surface 31 by about 2 mm, so that the height of the liquid-spray-failure detecting device 20 can be reduced.

FIG. 8 is a graph for explaining a relation between the distance between the nozzle head 16 and the mist shielding plate 40 and the width of the elongated hole 41 in the case of the mist m having the medium diameter. If the width of the elongated hole 41 is small, it is possible to effectively prevent the contamination of the optical system due to the mist m and the false detection. For example, it is preferable that, if the mist shielding plate 40 is located away from the head nozzle surface 31 by about 4 mm, the elongated hole 41 has the width of about 2.5 mm in the moving direction of the nozzle head 16, and if the mist shielding plate 40 is located away from the head nozzle surface 31 by about 2 mm, the elongated hole 41 has the width of about 0.5 mm in the moving direction of the nozzle head 16.

If the mist m has a large diameter, the elongated hole 41 needs to have a narrow width of about 0.1 mm, because the distance from the trajectory to the mist m is small. On the other hand, if the mist m has a small diameter, the elongated hole 41 needs to have a large width of about 5.0 mm, because the distance from the trajectory to the mist m is large.

The width of the elongated hole 41 needs to be determined in consideration of spray position accuracy, mounting position accuracy, detection range, or the like, so that the ink droplet 32 is properly sprayed to the light beam LB. For example, if the detection range is ±0.5 mm, the width of the elongated hole 41 is set to about 2.5 mm in consideration of the spray position accuracy, the mounting position accuracy, and the like. In this case, if the distance between the nozzle head 16 and the mist shielding plate 40 is set to about 4 mm, it is possible to prevent the contamination of the optical system due to the mist m and the false detection.

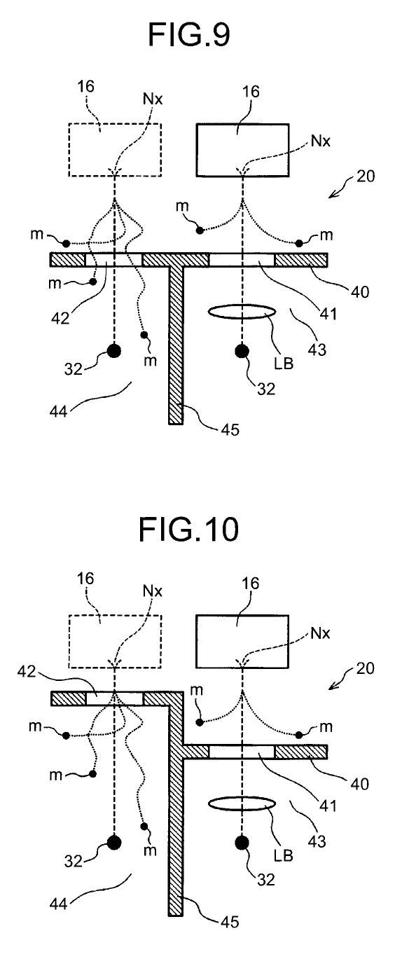

FIG. 9 is a schematic diagram for explaining a detection operation of liquid-spray-failure and an flushing operation that are performed by the nozzle head 16 and the liquid-spray-failure detecting device 20 at separate areas according to a first modified example of the embodiment.

The mist shielding plate 40 includes the elongated hole 41 and an elongated hole 42 used for the flushing operation. A space 43 is arranged under the elongated hole 41, and the ink droplet 32 enters the space 43 through the elongated hole 41. The light beam LB passes through the space 43. On the other hand, a space 44 is arranged under the elongated hole 42, and the ink droplet 32 enters the space 44 through the elongated hole 42. A partition plate 45 is arranged between the space 43 and the space 44, so that the ink droplet 32 cannot be moved from the space 43 to the space 44. A position of the nozzle head 16 upon the flushing operation is indicated by a dotted line shown in FIG. 9.

The flushing operation is performed as one of cleaning functions to flush high-viscosity ink from the nozzle hole Nx. Because an amount of the ink droplet 32 sprayed upon the flushing operation is larger than that of the ink droplet 32 sprayed upon the detection operation, a larger amount of the mist m is generated upon the flushing operation than the detection operation.

For example, when it is checked whether the nozzle head 16 has spray failure such that the ink droplet 32 cannot be sprayed or the ink droplet 32 is sprayed at an angle, the nozzle head 16 is moved to a position for detecting the liquid-spray-failure indicated by a solid line shown in FIG. 9 with respect to the mist shielding plate 40. Then, the ink droplet 32 is sprayed from the nozzle head 16, and the liquid-spray-failure detecting device 20 detects the sprayed ink droplet 32. If the nozzle head 16 has the spray failure, a cleaning operation is performed on the nozzle head 16. When the nozzle head 16 performs the flushing operation, the nozzle head 16 is moved to a position for the flushing indicated by the dotted line shown in FIG. 9 with respect to the mist shielding plate 40. After the nozzle head 16 performs the flushing operation, a suction cap (not shown) forcibly suctions the ink from the nozzle head 16 and the nozzle head 16 is refilled with ink. The ink adhering to the head nozzle surface 31 is wiped by a wiper (not shown). Thus, the cleaning operation is completed.

As described above, because the detection operation and the flushing operation are performed at the separate areas, it is possible to prevent the problem of the ink-jet printer such that an optical system included in the liquid-spray-failure detecting device 20 is contaminated with a large amount of the mist m generated upon the flushing operation.

FIG. 10 is a schematic diagram for explaining the detection operation and the flushing operation that are performed by the nozzle head 16 and the liquid-spray-failure detecting device 20 at separate areas according to a second modified example of the embodiment.

In the same manner as the example shown in FIG. 9, the mist shielding plate 40 includes the elongated hole 41, the elongated hole 42, and the partition plate 45. Although the elongated hole 41 and the elongated hole 42 are located from the head nozzle surface 31 at a substantially equal distance in the example shown in FIG. 9, the elongated hole 42 is located closer to the head nozzle surface 31 than the elongated hole 41 in the example shown in FIG. 10.

As described with reference to FIG. 7, if the mist shielding plate 40 is located close to the nozzle head 16, variation in output of the light-receiving element 35 is increased. This is because the satellite Bs passes through the elongated hole 41 and floats on the optical path of the light beam LB. Therefore, the mist shielding plate 40 around the elongated hole 42 is located close to the nozzle head 16, so that it is possible to allow the mist m generated upon the flushing operation to enter the space 44 in an active manner and to prevent the contamination of a unit arranged near the liquid-spray-failure detecting device 20 and a unit included in the ink-jet printer due to the mist m.

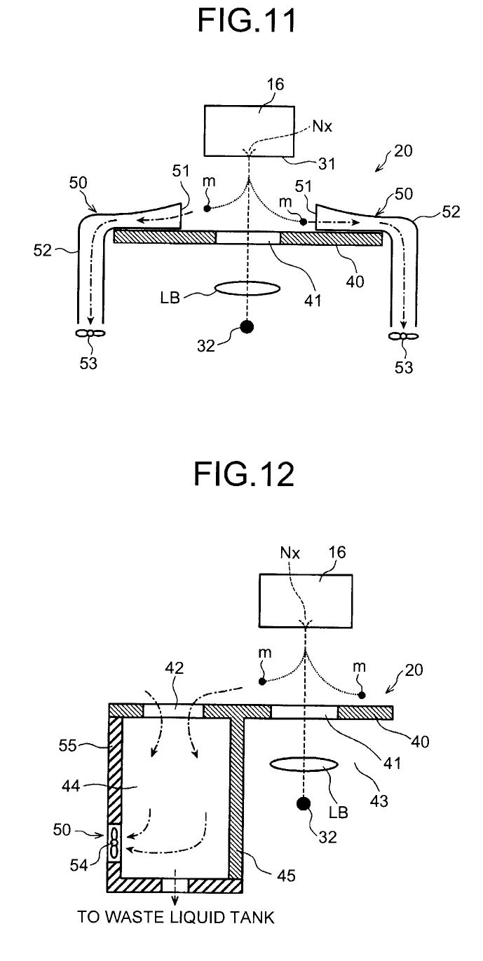

FIG. 11 is a schematic diagram for explaining the liquid-spray-failure detecting device 20 including mist suction members 50 that suck the mist m floating near the elongated hole 41 whereby the mist m is prevented from passing through the light beam LB according to a third modified example of the embodiment.

Suction tubes 52 each including a suction opening 51 are arranged such that the suction opening 51 is located near the elongated hole 41 or the nozzle hole Nx from which the ink droplet 32 is sprayed. When fans 53 are rotated, negative pressure is applied to the suction tubes 52, so that the mist m is sucked through the suction openings 51. Although the mist suction members 50 are arranged on the side of the mist shielding plate 40 to which the head nozzle surface 31 is opposed, the mist suction members 50 can be attached to the other side of the mist shielding plate 40 on which the light beam LB passes through.

The mist suction members 50 suck the mist m floating near the elongated hole 41 and the liquid-spray-failure detecting device 20, so that the mist m is prevented from passing through the light beam LB. Thus, it is possible to surely prevent the floating mist m from entering the optical path of the light beam LB thereby effectively preventing the false detection of the liquid-spray-failure and the adherence of the mist m to the optical system.

FIG. 12 is a schematic diagram for explaining the liquid-spray-failure detecting device 20 using a fan 54 as the mist suction member according to a fourth modified example of the embodiment.

As described with reference to FIGS. 9 and 10, the detection operation and the flushing operation are performed at the separate areas. The space 44 is covered with a cover 55 and the fan 54 is attached to an opening arranged on the cover 55. The fan 54 is rotated to apply negative pressure to the space 44, so that the air near the elongated hole 41 can be sucked through the elongated hole 42. Thus, it is possible to avoid the mist m generated upon the spray operation of the ink droplet 32 from floating near the liquid-spray-failure detecting device 20 or in the ink-jet printer and prevent the contamination due to ink.

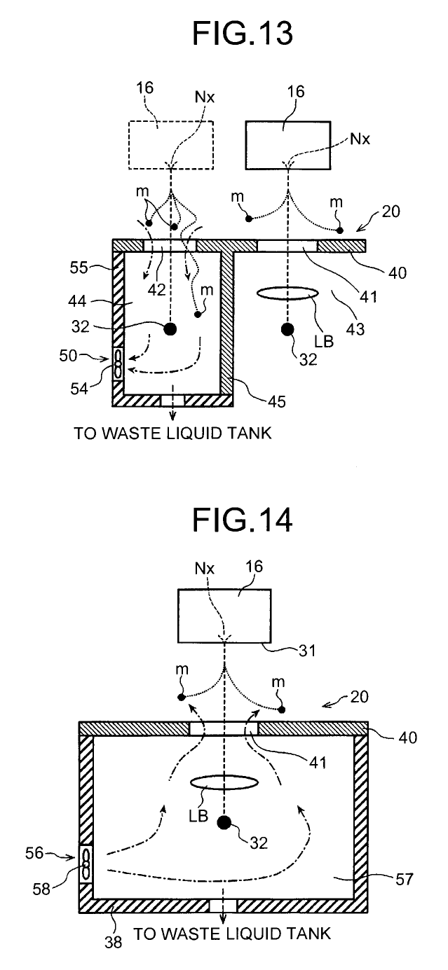

FIG. 13 is a schematic diagram for explaining the flushing operation performed by the liquid-spray-failure detecting device 20 using the elongated hole 42.

When the flushing operation is to be performed, the nozzle head 16 is moved to a position corresponding to the nozzle head 16 indicated by a dotted line shown in FIG. 13. Negative pressure is applied to the space 44 to suck a large amount of the mist m generated upon the flushing operation through the elongated hole 42, so that it is possible to avoid the mist m from floating in or near the liquid-spray-failure detecting device 20 or in the ink-jet printer, and prevent the contamination due to ink.

FIG. 14 is a schematic diagram for explaining the liquid-spray-failure detecting device 20 including a mist discharge unit 56 that discharges the mist m floating on the side of the mist shielding plate 40 near the light beam LB through the elongated hole 41 thereby preventing the mist m from passing through the light beam LB according to a fifth modified example of the embodiment.

A space 57 under the elongated hole 41 is covered with the casing 38, and a fan 58 is attached to an opening arranged on the casing 38. The fan 58 is rotated to apply positive pressure to the space 57, so that the air can be discharged from the space 57 through the elongated hole 41. Thus, it is possible to avoid the mist m generated upon the spray operation of the ink droplet 32 from floating in the space 57 and prevent the optical system from being contaminated with ink.

Alternatively, in the configuration shown in FIG. 11, the fan 53 is rotated to apply positive pressure to the suction tube 52 whereby the air is sprayed through the suction opening 51 to blow the mist m. Thus, it is possible to surely prevent the floating mist m from entering the optical path of the light beam LB and effectively prevent the false detection of the spray failure and the adherence of the mist m to the optical system. A sheet or a filter can be arranged downstream to capture the mist m, so that it is possible to prevent the contamination of a unit arranged near the liquid-spray-failure detecting device 20 or in the ink-jet printer due to the mist m.

Furthermore, if the liquid-spray-failure detecting device 20 shown in FIGS. 12 and 13 has a function of discharging the air as well as the function of sucking the air, it is possible to prevent the contamination of the liquid-spray-failure detecting device 20, a unit arranged near the liquid-spray-failure detecting device 20, or a unit arranged inside the ink-jet printer due to the mist m.

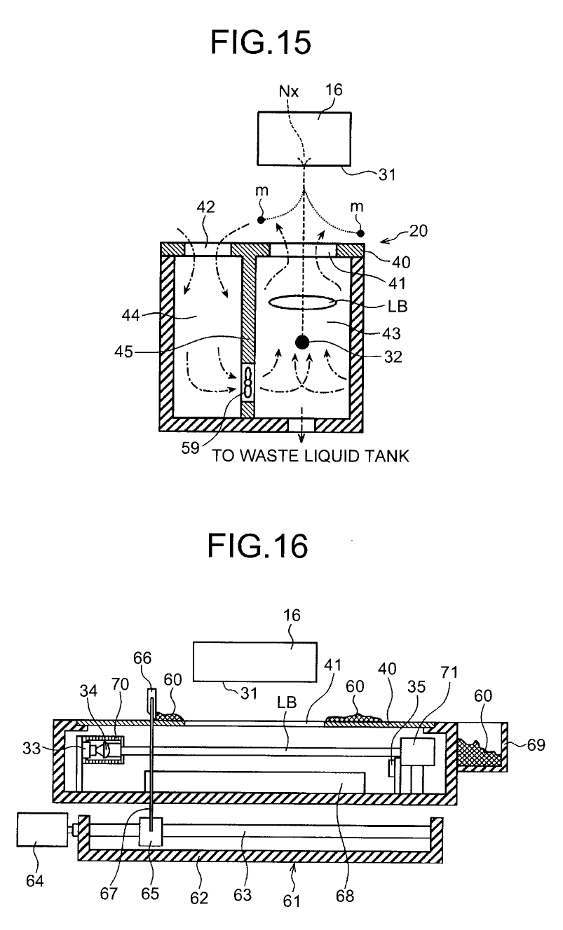

FIG. 15 is a schematic diagram for explaining the liquid-spray-failure detecting device 20 having functions of sucking and discharging the air according to a sixth modified example of the embodiment.

The space 43 is covered with a cover, and a fan 59 is attached to an opening arranged on the partition plate 45. Thus, the air is sucked into the space 44 through the elongated hole 42 as indicated by dashed-dotted lines shown in FIG. 15, while the air is sprayed from the space 43 through the elongated hole 41 as indicated by dashed-dotted lines shown in FIG. 15, so that it is possible to prevent the contamination of the liquid-spray-failure detecting device 20, a unit arranged near the liquid-spray-failure detecting device 20, or a unit arranged inside the ink-jet printer due to the mist m.

It is preferable that the air suction operation and the flushing operation as shown in FIGS. 11 to 15 are performed by moving only the mist m without affecting the spray of the ink droplet 32. Furthermore, a filter can be arranged to prevent the adherence of ink to the fan 59 and the spray of ink to outside.

FIG. 16 is a schematic diagram for explaining a cleaning unit 61 that cleans the mist shielding plate 40 around the elongated hole 41 according to a seventh modified example of the embodiment.

If the ink-jet printer is operated for a long time, the mist m is accumulated and an ink clump 60 is formed on the mist shielding plate 40. If the ink clump 60 is increased in size, the ink clump 60 grows in height toward the nozzle head 16 and is brought into contact with the head nozzle surface 31, resulting in nozzle clogging or false detection because the accumulated mist m falls down through the elongated hole 41 and is mistaken for the ink droplet 32. Therefore, it is preferable that the cleaning unit 61 is arranged to remove the ink clump 60 from the mist shielding plate 40.

The cleaning unit 61 includes a frame 62 by which a screw shaft 63 is supported such that the screw shaft 63 can be rotated by a motor 64 that is connected to one end of the screw shaft 63. A nut-like movable member 65 is attached to the screw shaft 63, so that the movable member 65 is movable in the lateral direction with the rotation of the screw shaft 63. A base end of a supporting rod 67 is fixedly attached to the movable member 65. A wiper 66 is attached to an end of the supporting rod 67.

The motor 64 is driven to rotate the screw shaft 63 and move the movable member 65 in the lateral direction whereby the wiper 66 is moved on the upper surface of the mist shielding plate 40 to clean the mist shielding plate 40 around the elongated hole 41. The ink clump 60 removed by the wiper 66 is collected in a waste liquid tank 68 arranged under the elongated hole 41 and a waste liquid tank 69 arranged adjacent to the mist shielding plate 40.

The same components, such as the light-emitting element 33, the collimating lens 34, and the light-receiving element 35, are indicated by the same reference numerals in FIG. 16. An aperture 70 shapes the light beam LB, and a stray-light processing mechanism 71 attenuates the light beam LB.

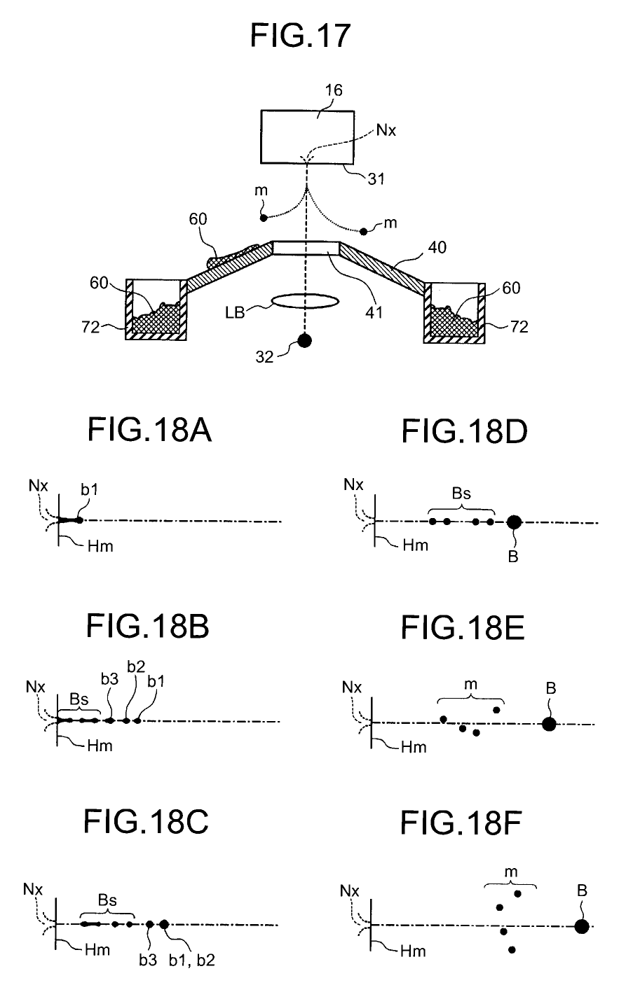

FIG. 17 is a schematic diagram for explaining the mist shielding plate 40 serving as a cleaning unit according to an eighth modified example of the embodiment.

The mist shielding plate 40 is tilted so that the mist m flows downward along the tilt of the mist shielding plate 40 before the mist m is accumulated on the mist shielding plate 40. This method is simple and effective without the need for a wiping mechanism. A waste liquid tank 72 is arranged downstream of the tilted surface of the mist shielding plate 40, so that the ink flowing down on the tilted surface can be effectively collected in the waste liquid tank 72.

It is described above that the liquid-spray-failure detecting device detects the spray failure by causing the light-receiving element 35 to receive the scattered light S generated when the ink droplet 32 strikes the light beam LB. However, the liquid-spray-failure detecting device is not limited to this type of apparatus. The present invention can be applied to a liquid-spray-failure detecting device that detects shadow generated when the ink droplet 32 strikes the light beam LB by using a light receiving element arranged on the light axis L.

If a large number of the nozzle heads 16 are arranged, it is possible that multiple elongated holes 41 are arranged on the mist shielding plate, so that the spray failure can be concurrently detected for the nozzle heads 16.

According to an aspect of the present invention, it is possible to properly detect spray failure of a liquid droplet without being affected by mist and prevent adherence of the mist to an optical system thereby avoiding output reduction of a light emitting element and sensitivity reduction of a light receiving element.

Furthermore, it is possible to effectively prevent false detection of liquid-spray-failure and adherence of the mist to the optical system due to a large amount of mist generated upon a flushing operation.

Moreover, it is possible to surely prevent floating mist from entering an optical path of a light beam thereby effectively preventing the false detection of the liquid-spray-failure and the adherence of the mist to the optical system.

Furthermore, it is possible to avoid accumulated mist from disturbing a floating liquid droplet or interfering with movement of a nozzle head thereby effectively preventing the false detection of the liquid-spray-failure and the adherence of the mist to the optical system.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A device for detecting a liquid spray failure including a light-emitting element that emits a light beam and a light-receiving element that receives the light beam emitted from the light-emitting element, the light emitting element being installed in such a manner that the light beam collides with a sprayed liquid droplet so that the device detects a spray failure of the liquid droplet based on an output change of the light-receiving element, the device comprising:
a mist shielding plate that includes a first elongated hole through which liquid droplets sprayed from a plurality of nozzles pass and that prevents a mist floating apart from the liquid droplets from passing through the first elongated hole.

2. The device according to claim 1, wherein the mist shielding plate further includes
a second elongated hole for flushing a clogged ink droplet in the nozzle, and
a partition plate that partitions a first space through the first elongated hole and a second space through the second elongated hole.

3. The device according to claim 1, further comprising a mist suction unit that suctions a mist floating around the first elongated hole thereby preventing the mist from entering in a path of the light beam.

4. The device according to claim 2, further comprising a mist suction unit that suctions a mist floating around the first elongated hole thereby preventing the mist from entering in a path of the light beam.

5. The device according to claim 1, further comprising a mist discharge unit that discharges a mist floating around the light beam from the first elongated hole thereby preventing the mist from entering in a path of the light beam.

6. The device according to claim 2, further comprising a mist discharge unit that discharges a mist floating around the light beam from the first elongated hole thereby preventing the mist from entering in a path of the light beam.

7. The device according to claim 1, further comprising a cleaning unit that cleans the mist shielding plate around the first elongated hole.

8. An ink-jet recording apparatus comprising:
a nozzle head that includes a plurality of nozzles arranged in line each spraying an ink droplet; and
an ink-spray-failure detecting device including
a light-emitting element that emits a light beam,
a light-receiving element that receives the light beam emitted from the light-emitting element, wherein
the light emitting element is installed in such a manner that the light beam collides with a sprayed ink droplet so that the ink-spray-failure detecting device detects a spray failure of the ink droplet based on an output change of the light-receiving element, and
a mist shielding plate that includes a first elongated hole through which ink droplets sprayed from the nozzles pass and that prevents a mist floating apart from the ink droplets from passing through the first elongated hole.

9. The ink-jet recording apparatus according to claim 8, wherein a width of an elongated side of the first elongated hole in a direction along the nozzles is 0.1 millimeter to 5.0 millimeters.

10. The ink-jet recording apparatus according to claim 8, wherein a distance between the mist shielding plate and the nozzles is 2 millimeters to 6 millimeters.

11. The ink-jet recording apparatus according to claim 9, wherein a distance between the mist shielding plate and the nozzles is 2 millimeters to 6 millimeters.

12. The ink-jet recording apparatus according claim 8, wherein
the mist shielding plate further includes
a second elongated hole for flushing a clogged ink droplet in the nozzle, and
a partition plate that partitions a first space through the first elongated hole and a second space through the second elongated hole, and
a distance between the second elongated hole and the nozzles is shorter than a distance between the first elongated hole and the nozzles.

13. The ink-jet recording apparatus according claim 9, wherein
the mist shielding plate further includes
a second elongated hole for flushing a clogged ink droplet in the nozzle, and
a partition plate that partitions a first space through the first elongated hole and a second space through the second elongated hole, and
a distance between the second elongated hole and the nozzles is shorter than a distance between the first elongated hole and the nozzles.

14. The ink-jet recording apparatus according claim 10, wherein
the mist shielding plate further includes
a second elongated hole for flushing a clogged ink droplet in the nozzle, and
a partition plate that partitions a first space through the first elongated hole and a second space through the second elongated hole, and
a distance between the second elongated hole and the nozzles is shorter than a distance between the first elongated hole and the nozzles.

15. The ink-jet recording apparatus according claim 11, wherein
the mist shielding plate further includes
a second elongated hole for flushing a clogged ink droplet in the nozzle, and
a partition plate that partitions a first space through the first elongated hole and a second space through the second elongated hole, and
a distance between the second elongated hole and the nozzles is shorter than a distance between the first elongated hole and the nozzles.
